(19) United States
(12) Patent Application Publication
(10) Pub. No.: US 2007/0131436 A1
(43) Pub. Date: Jun. 14, 2007

(54) Cultivator and tiller

(76) Inventor: Gerald L. Asay, Bozeman, MT (US)

Correspondence Address: JAMES RAY & ASSOCIATES, 2640 PITCAIRN ROAD, MONROEVILLE, PA, 15146, US

(21) Appl. No.: 11/601,159

(22) Filed: Nov. 17, 2006

Related U.S. Application Data
(60) Provisional application No. 60/749,186, filed on Dec. 9, 2005.

(51) Int. Cl. A01B 33/00

(52) U.S. Cl. 172/41

(57) ABSTRACT

A hand held garden tool for at least one of cultivating, tilling, weeding, aerating and fertilizing gardens and other landscaped areas. The hand held garden tool comprises a housing member having a predetermined shape and formed of a predetermined material. The housing member having a handle member disposed therein. There is a first rotatable shaft engageable with a first portion of the housing member and a plurality of tines having a predetermined length and disposed on such first rotatable shaft for cultivating, tilling, weeding, aerating and fertilizing gardens and other landscaped areas. A motor is disposed in the housing member and connected to the first rotatable shaft for rotating such plurality of tines. A power source is disposed one of on and in a rear portion of the housing member and connected to the motor for providing power to the motor. A switch member is disposed on an exterior portion of the housing member and connected between the motor and the power source for opening and closing an electrical circuit between the power source and the motor.

### CROSS REFERENCE TO RELATED APPLICATIONS

This application is closely related to and claims benefit from U.S. Provisional Application Ser. No. 60/749,186 filed Dec. 09, 2005.

### FIELD OF THE INVENTION

The present invention relates, in general, to a garden tool, and, more particularly, the present invention relates to a hand held garden tool that provides a cultivating and tilling tool that simplifies garden chores.

### BACKGROUND OF THE INVENTION

Gardens and flowerbeds are quite enjoyable and are a joy to look at but are difficult to maintain. Plants require well tilled soil for best growth that is free from weeds. To maintain a beautiful and healthy garden requires significant work. Many gardeners risk pain and/or injury to the joints by hand pruning or using heavy or bulky tools to prepare the garden. Weeding is also a chore which requires a great deal of kneeling. These tasks, such as cultivating, tilling, weeding aerating and fertilizing, can become burdensome but are necessary for one to enjoy the fruits of a garden or the beauty of a flower bed.

Thus, it would be advantageous if there were a simple tool available that could perform all of the these tasks without harm to the hands or wrists and could make gardening and landscaping a much more enjoyable hobby.

### SUMMARY OF THE INVENTION

In a first aspect the present invention provides a hand held garden tool for at least one of cultivating, tilling, weeding, aerating and fertilizing gardens and other landscaped areas. The hand held garden tool comprises a housing member having a predetermined shape and formed of a predetermined material. The housing member having a handle member disposed therein. There is a first rotatable shaft engageable with a first portion of the housing member and a plurality of tines having a predetermined length and disposed on such first rotatable shaft for cultivating, tilling, weeding, aerating and fertilizing gardens and other landscaped areas. A motor means is disposed in the housing member and connected to the first rotatable shaft for rotating such plurality of tines. A power source is disposed one of on and in a rear portion of the housing member and connected to the motor means for providing power to the motor means. A switch member is disposed on an exterior portion of the housing member and connected between the motor means and the power source for opening and closing an electrical circuit between the power source and the motor means.

### OBJECTS OF THE INVENTION

It is, therefore, one of the primary objects of the present invention is to provide a hand held garden tool that can be used for cultivating and tilling.

Another object of the present invention is to provide a hand held garden tool that is battery operated.

Still another object of the present invention is to provide a hand held garden tool that can be used for weeding, aerating and fertilizing gardens or other small landscaped areas.

Yet another object of the present invention is to provide a hand held garden tool that can be made in different sizes.

Another object of the present invention is to provide a hand held garden tool that has rotatable tines for digging up the soil.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the hand held garden tool according to an embodiment of the invention.

FIG. 2 is a perspective view of gear assembly for turning the tines of the garden tool shown in FIG. 1.

FIG. 3 is a perspective view of the hand held garden tool showing the battery compartment and the on/off switch.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a hand held garden tool, generally designated 10, for at least one of cultivating, tilling, weeding, aerating and fertilizing gardens and other landscaped areas. The hand held garden tool 10 comprises a housing member 2 having a predetermined shape and formed of a predetermined material. The housing member 2 having a handle member 4 disposed therein. There is a first rotatable shaft 6 that is engageable with a first portion of the housing member 2 and a plurality of tines 8 having a predetermined length and disposed on such first rotatable shaft 6 for cultivating, tilling, weeding, aerating and fertilizing gardens and other landscaped areas. A motor means, generally designated 20, is disposed in the housing member 2 and connected to the first rotatable shaft 6 for rotating such plurality of tines 8. A power source 12 is disposed one of on and in a rear portion of the housing member 2 and connected to the motor means 20 for providing power to the motor means 20. A switch member 14 is disposed on an exterior portion of the housing member 2 and connected between the motor means 20 and the power source 12 for opening and closing an electrical circuit between the power source 12 and the motor means 20.

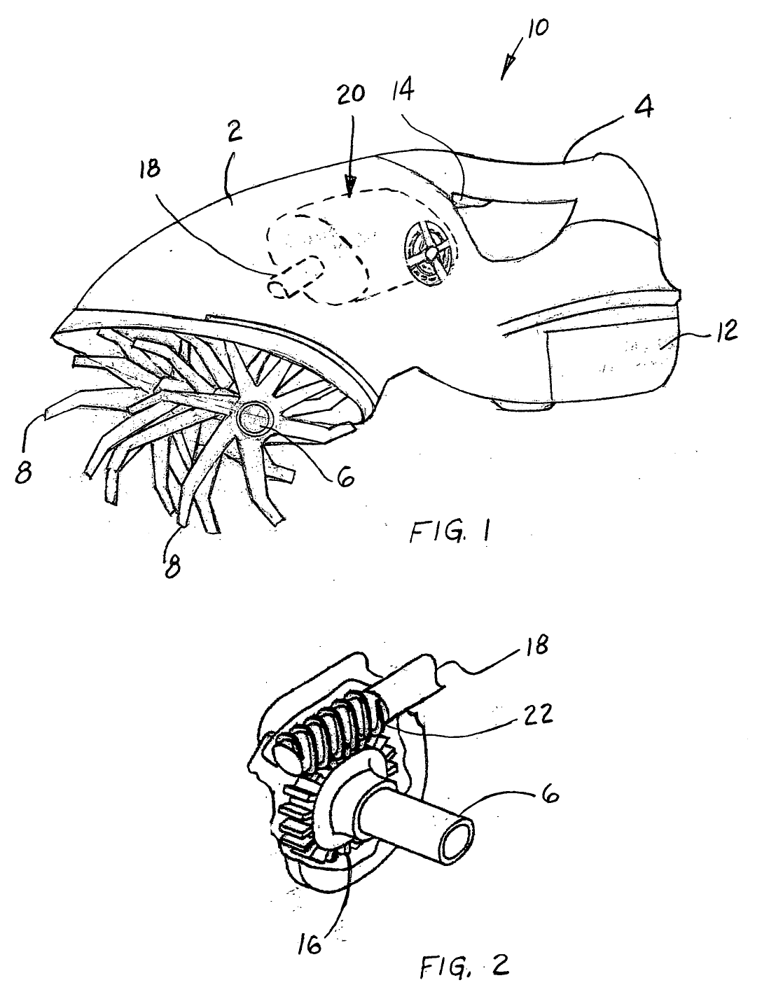

The first rotatable shaft 6 has a spur gear 16 disposed closely adjacent an end of such shaft 6. The motor means 20 has a second rotatable shaft 18 driven by the motor 20. As seen in FIG. 2 the second rotatable shaft 18 further has a worm gear 22 disposed on an end of the second rotatable shaft 18 that is away from the motor 20. The worm gear 22 is for engagement with the spur gear 16 for rotating shaft 6 which causes the plurality of tines 8 to rotate and thereby digging up the soil as desired.

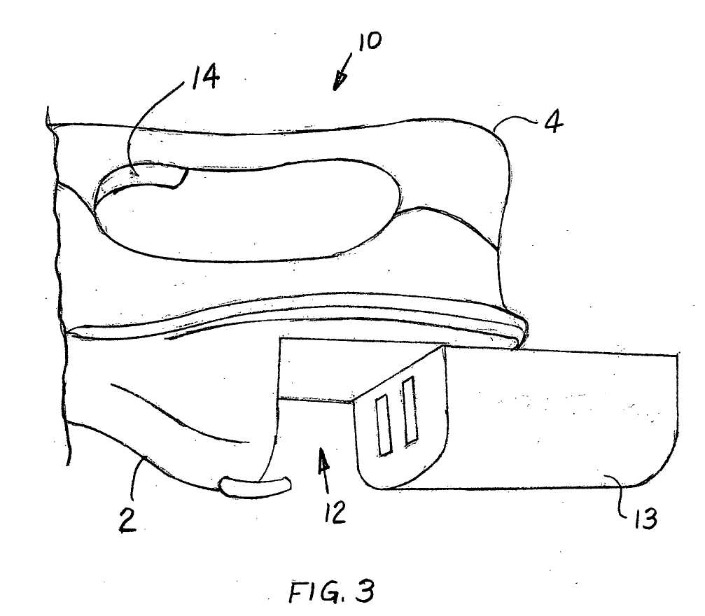

The power source 12 for providing power to the motor means 20 is one of a battery 13, seen in FIGS. 1 and 3, and power obtained from a 110 volt electrical circuit (not shown). It is presently preferred that such power source 12 is a battery 13 so that the garden tool 10 is completely portable being able to be used anywhere as opposed to being used only close to a 110 volt electrical circuit as would be required with the need of a cord.

Further, it is presently preferred that such power source 12 is one of a dry cell and a rechargeable battery 13 and even more preferred that such battery 13 is a rechargeable battery 13. The rechargeable battery 13 can be one of a twelve volt, fourteen volt and an eighteen volt battery. The battery 13 is disposed in the rear portion of the housing member 2, regardless of the size of the battery. The size of the battery is dependent upon the size of the garden tool 10. Such garden tool 10 can be made in several sizes depending upon the usage. One size, the largest size, employs an 18 volt battery 13. In this case the garden tool 10 has larger tines 8. The diameter of the plurality of tines 8 is between about 3¼ and about 3¾ inches. The diameter being measured from the outer ends of a blade of the tines 8 to the outer end of a radially opposed blade of the tine. The circle is an imaginary circle drawn around the ends of the blades of the tines 8 with the individual blades of the tines essentially being a radii. This tool 10 with the larger tines would be used for larger areas.

A second size for the garden tool 10 would utilize a fourteen volt battery 13. In this case the garden tool 10 has smaller tines 8. Thus, the diameter of the plurality of tines 8 for this tool 10 is between about 2¼ and about 2¾ inches. Again, the diameter being measured from the outer end of a blade of the tines 8 to the outer end of a radially opposed blade of the tine. The individual blades of the tines 8 essentially being a radii.

A third garden tool 10 utilizes a twelve volt battery 13. In this tool 10 the circumference of the plurality of tines 8 is between about 1¾ and about 2⅜ inches. Again the diameter being measured from the outer end of a blade of the tines 8 to the outer end of a radially opposed blade of the tine 8. The individual blades of the tines 8 essentially being a radii. Such battery 13 could be as small as a nine volt battery for this tool 10; however, the twelve volt battery is preferred.

It should be noted that the plurality of tines 8 in all of the garden tools 10 are four sets of tines 8. The tines 8 are different sizes for the various tools 10 but the number of tines 8 are the same. Further, the width of the opening in the front area of the housing member 2 for holding the four tines 8 is between about 3 and about 4 inches. The smaller opening is for the two smaller tools 10 and the largest opening is for the largest garden tool 10.

The predetermined material for forming the housing member 2 is plastic and a variety of plastics can be used to form the housing member 2; however it is important that the plastic be impact resistant.

Thus, the present invention provides a portable hand held garden tool 10 that can be used for a variety of applications. It is used for cultivating, tilling, weeding, aerating and fertilizing. The garden tool 10 features rotating tines 8 on the front of the tool 10 that are activated by means of a battery 13 operated motor 20. The four tines 8 are aligned one beside the other as is seen in the Drawing Figures. The tool 10 has a handle 4 built into the housing member 2 and the handle 4 is easy to grip and fits comfortably in the hand. The trigger switch 14 on the underside of the handle 2 is easy to operate to power the garden tool 10. The tool comes in three sizes so as to meet the gardening and landscaping needs of the user.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. A hand held garden tool for at least one of cultivating, tilling, weeding, aerating and fertilizing gardens and other landscaped areas, said hand held garden tool comprising:
(a) a housing member having a predetermined shape and formed of a predetermined material, said housing member having a handle member disposed thereon;
(b) a first rotatable shaft engageable with a first portion of said housing;
(c) a plurality of tines having a predetermined length and disposed on said first rotatable shaft for cultivating, tilling, weeding, aerating and fertilizing gardens and other landscaped areas;
(d) a motor means disposed in said housing and connected to said first rotatable shaft for rotating said plurality of tines;
(e) a power source disposed one of on and in a rear portion of said housing member and connected to said motor means for providing power to said motor means;
(f) a switch member disposed on an exterior portion of said housing member and connected between said motor means and said power source for opening and closing an electrical circuit between said power source and said motor means.

2. The apparatus, according to claim 1, wherein said first rotatable shaft has a spur gear disposed thereon.

3. The apparatus, according to claim 2, wherein said motor means further includes a second rotatable shaft driven by said motor, said second rotatable shaft having a worm gear disposed on an end of said second rotatable shaft away from said motor for engagement with said spur gear for rotating said tines.

4. The apparatus, according to claim 1, wherein said power source is one of a battery and power obtained from a 110 volt electrical circuit.

5. The apparatus, according to claim 4, wherein said power source is a battery.

6. The apparatus, according to claim 5, wherein said battery is one of a dry cell and a rechargeable battery.

7. The apparatus, according to claim 6, wherein said battery is a rechargeable battery.

8. The apparatus, according to claim 7, wherein said rechargeable battery is one of a twelve volt, fourteen volt and an eighteen volt battery.

9. The apparatus, according to claim 8, wherein said rechargeable battery is an eighteen volt battery.

10. The apparatus, according to claim 9, wherein a diameter of said plurality of tines is between about 3¼ and about 3¾ inches, said diameter is measured from an outer end of a blade of said tine to outer end of a radially opposed blade of said tine.

11. The apparatus, according to claim 8, wherein said rechargeable battery is one of a fourteen volt battery.

12. The apparatus, according to claim 11, wherein a circumference of said plurality of tines is between about 2¼ and about 2¾ inches, said diameter is measured from an outer end of a blade of said tine to outer end of a radially opposed blade of said tine.

13. The apparatus, according to claim 8, wherein said rechargeable battery is one of a twelve volt battery.

14. The apparatus, according to claim 13, wherein a circumference of said plurality of tines is between about 1¾ and about 2⅜ inches, said diameter is measured from an outer end of a blade of said tine to outer end of a radially opposed blade of said tine.

15. The apparatus, according to claim 1, wherein said power source is disposed in a rear portion of said housing.

16. The apparatus, according to claim 1, wherein said predetermined material for said housing is plastic.

17. The apparatus, according to claim 16, wherein said plastic is impact resistant.

18. The apparatus, according to claim 1, wherein said plurality of tines is four.

19. The apparatus, according to claim 18, wherein a width of a front area of said housing member for holding said four tines is between about 3 and about 4 inches.
